(19) United States
(12) Patent Application Publication
(10) Pub. No.: US 2011/0080327 A1
(43) Pub. Date: Apr. 7, 2011

(54) PORTABLE WIRELESS MACHINE

(75) Inventors: Hiroaki Kobayashi, Miyagi (JP); Haruhiko Kakitsu, Miyagi (JP); Takeshi Yamaguchi, Kanagawa (JP)

(73) Assignee: PANASONIC CORPORATION, Osaka (JP)

(21) Appl. No.: 12/997,235

(22) PCT Filed: Feb. 19, 2009
(86) PCT No.: PCT/JP2009/000703

§ 371 Date: Dec. 9, 2010

(30) Foreign Application Priority Data
Jun. 10, 2008 (JP) 2008-151976

(51) Int. Cl. H01Q 1/24

(52) U.S. Cl. 343/702

(57) ABSTRACT

A decrease in antenna currents that are oriented in opposite directions and that flow through enclosures and enhancement of an antenna characteristic are accomplished without impairment of a design characteristic of the enclosures and while being made feasible to achieve a reduction in size and thickness.

In a portable radio that has an upper enclosure 11, a lower enclosure 12, and an intermediate enclosure 13 and that can assume a portrait open state and a landscape open state, when the landscape open state is achieved as a result of turning action of a second hinge member 32, an antenna element 15 of the upper enclosure 11 is connected to a radio circuit 23 on a second circuit board 22 of the lower enclosure 12 by way of a connection line 25. A first hinge member 31 in the intermediate enclosure 13 is earthed to a ground of the second circuit board 22 of the lower enclosure 12 by way of a connection conductor 26 and a reactance element 35. The first hinge member 31 is thereby caused to act as an earth line, to thus reduce opposite-phase antenna currents flowing through the upper enclosure 11 and the lower enclosure 12 that oppose each other.

### TECHNICAL FIELD

The present invention relates to a portable radio equipped with an antenna mounted in; for instance, an enclosure, like a foldable enclosure.

### BACKGROUND ART

For instance, like a portable phone described in connection with Patent Document 1, a widely-used portable radio, like a portable phone terminal, has an enclosure that is separated into an upper enclosure and a lower enclosure, which are joined together by way of a hinge, and that has a structure which enables opening and closing or folding of the enclosures.

As disclosed in; for instance, Patent Document 2, there is also available a portable information processing device using rotatable enclosures that have two hinge members and two degrees of freedom. In the configuration, it is possible to select either a portrait open state in which the upper enclosure and the lower enclosure are opened while their short sides remain close to each other or a landscape open state in which the upper enclosure and the lower enclosure are opened while their long sides remain close to each other.

Patent Document 1 discloses a configuration for enhancing antenna performance when a portable radio of this type is equipped with an antenna. In the configuration, in order to utilize a shield box built in enclosures or a shield box provided in the upper enclosure as an antenna, the shield box of the lower enclosure and the shield box of the upper enclosure are electrically connected by way of a flexible cable.

In order to effectively utilize a size-limited space, such as enclosures, and implement a high performance antenna, an enclosure dipole antenna utilizing the enclosures as an antenna can be configured in relation to a portable radio. For instance, a high performance enclosure dipole antenna having a radiation area equal in size to enclosures can be configured by means of: forming an upper enclosure and a lower enclosure from a conductive metal member; placing in each of the enclosures a conductive metal frame having substantially the same size with the size of the enclosures; using a ground pattern of a circuit board in the enclosures; and using these conductive portions as a portion of the antenna.

For instance, Patent Document 3 discloses a configuration, as another technique for enhancing antenna performance, in which a conductive member having one earthed end and another open end is placed in the vicinity of a feeding point of the antenna in order to diminish a local mean SAR (Specific Absorption Rate). In the example, the conductive member is utilized as an earth line, and the length of the conductive member is set to a quarter of a wavelength of a frequency band used by the conductive member in such a way that the conductive member causes resonance. A decrease in SAR is accomplished by reducing an antenna current flowing through a ground plate.
Patent Document 1: JP-A-2002-335180
Patent Document 2: JP-A-2003-60759
Patent Document 3: JP-A-2002-353719

### DISCLOSURE OF THE INVENTION

### Problem that the Invention is to Solve

When an enclosure dipole antenna, such as that mentioned above, is configured, the enclosures are brought into open when the portable radio is used, and the portable radio is used while one side of an outer shape of the upper enclosure and one side of an outer shape of the lower enclosure remain close to each other in a side-by-side manner. Thus, single sides of the respective enclosures come proximate to each other. During communication, an antenna current flowing through the upper enclosure and an antenna current flowing through the lower enclosure become opposite to each other (the electric currents become opposite in phase to each other), whereupon the antenna currents come into close proximity to each other. For this reason, the antenna currents that flow in close proximity to each other and that are opposite in directions cancel each other, as a result of which the entire antenna current decreases. As a consequence, an effective radiation area of the enclosure dipole antenna decreases, which raises a problem of narrowing of a frequency band at which a sufficient antenna gain is acquired.

In particular, when the foldable portable radio is used in its landscape open state, one side of the upper enclosure and one side of the lower enclosure, which remain in close proximity to each other, are long. Therefore, the degree of cancellation of the antenna current also becomes greater. Moreover, in the case of an antenna that receives a digital broadcast (DTV), like a television program, that is broadcast as a so-called one-segment (Registered Trademark) broadcast, a wavelength of a corresponding frequency band (473 to 770 MHz) is comparatively longer than the size of the enclosures and also has a wider band. Therefore, deterioration of the antenna characteristic becomes noticeable.

A conceivable solution to the drawback is to provide an earth line formed from; for instance, a conductive member, and change a state of distribution of the antenna current. However, such an earth line is usually laid so as to protrude long outside of each of the enclosures, so that the portable radio will become bulky or a design characteristic of the enclosures will be impaired. Some device configurations may encounter difficulty in arranging such an earth line or miniaturizing or reducing the thickness of the portable radio.

The present invention has been conceived in light of the circumstance and aims at providing a portable radio that can be miniaturized and reduced in thickness without involvement of deterioration of a design characteristic of enclosures and that can reduces an antenna current in opposite direction flowing through the enclosure and enhance an antenna characteristic.

### Means for Solving the Problem

The present invention provides a portable radio comprising: a first enclosure; a second enclosure; a hinge section that joins the first enclosure to the second enclosure in a relatively rotatable or movable state; an antenna element having a conductive member to be placed in the first enclosure; a circuit board to be placed in the second enclosure; a radio circuit that is placed on the circuit board and connected to the antenna element; a conductive first hinge member and a conductive second hinge member that are provided in the hinge section and that have mutually-different rotational axes for turning the first enclosure and the second enclosure; a reactance element that is provided on the circuit board and that is earthed at one end; and a connector that electrically connects the first hinge member to the reactance element while the first enclosure and the second enclosure remain open as a result of turning action of the second hinge member.

By means of the configuration, the first hinge member can be caused to act as an earth line. Antenna currents that flow in opposite directions through sides on ends of the first enclosure and the second enclosure opposing each other are reduced while the first enclosure and the second enclosure are in close proximity to each other, and influence of cancellation of the opposite-phase antenna currents can be suppressed, so that an antenna characteristic can be enhanced. Further, utilizing the hinge member provided in the hinge section as an earth line obviates a necessity for additional provision of a new constituent element for an earth line. Moreover, a conductive element of the earth line does not protrude out of the enclosures, so that a reduction in size and thickness can be accomplished without impairing a design characteristic of the enclosures.

The present invention also includes the portable radio in which the first enclosure and the second enclosure each are formed into a shape having long sides and short sides; and the first hinge member is earthed to the circuit board by way of the reactance element while the enclosures remain open with the long side of the first enclosure and the long side of the second enclosure in close proximity to each other.

By means of the configuration, the first hinge member acts as an earth line while the enclosures are opened with the long sides of the enclosures in close proximity to each other, and the antenna currents flowing to the earth line increase. Hence, the antenna currents flowing in opposite directions in neighborhoods of the ends of the long sides of the enclosures can be reduced while the enclosures are mutually opposing each other and in close proximity to each other. Influence of cancellation of opposite-phase antenna currents can be reduced, and deterioration of a characteristic of the antenna gain, or the like, can be suppressed.

The present invention also includes the portable radio in which the first enclosure and the second enclosure are open-able and closable between a landscape open state in which the long sides come into close proximity to each other as a result of turning action of the second hinge member, to thus open the enclosures, and a portrait open state in which the short sides come into close proximity to each other as a result of turning action of the first hinge member, to thus open the enclosures; and the first hinge member is earthed to the circuit board by way of the reactance element in the landscape open state.

By means of the configuration, in the enclosures that can assume the landscape open state and the portrait open state, the first hinge member is caused to act as an earth line while the enclosures remain in a landscape open state with the long sides of the enclosures in close proximity to each other, whereby the characteristic, such as an antenna gain, can be enhanced.

The present invention also includes the portable radio further comprising a first switching circuit for switching a connection path of the radio circuit; a second switching circuit for switching a connection path of the first hinge member; and a control circuit for controlling a state of connection of the first switching circuit and a state of connection of the second switching circuit, wherein the control circuit selects, when the first enclosure and the second enclosure remain open as a result of turning action of the second hinge member, a first connection state in which the first switching circuit connects the radio circuit to the antenna element and in which the second switching circuit connects the first hinge member, the connector, and the reactance element together; and the control circuit selects, when the first enclosure and the second enclosure remain closed as a result of turning action of the second hinge member, a second connection state in which the first switching circuit connects the radio circuit to the second switching circuit and in which the second switching circuit connects the first hinge member and the connector to the first switching circuit, thereby bringing the first hinge member in connection with the radio circuit.

By means of the configuration, a connection path is switched according to an open state of the enclosures, whereby it becomes possible to earth the first hinge member by way of the reactance element, thereby letting the first hinge member act as an earth line. Further, it becomes possible to use the first hinge member as a path for connection with the antenna because the first hinge member can be connected to the radio circuit.

The present invention also relates to the portable radio in which the first enclosure and the second enclosure each are configured into a shape having long sides and short sides and are open-able and closable between a landscape open state in which the long sides come in close proximity to each other as a result of turning action of the second hinge member, to thus open the enclosures, and a portrait open state in which the short sides come into close proximity to each other as a result of turning action of the first hinge member, to thus open the enclosures; and the control circuit selects the first connection state in the landscape open state and the second connection state in the portrait open state.

In the enclosures that can assume the landscape open state and the portrait open state, the connection path is switched by means of the configuration, thereby earthing the first hinge member in the landscape open state by way of the reactance element and letting the same act as an earth line. Further, the first hinge member can be used as a path for connection with the antenna because the first hinge member can be connected to the radio circuit in the portrait open state.

The present invention also includes the portable radio further comprising: a cable that is laid by way of the hinge section and that electrically connects the antenna element to the circuit board; and a connection path for electrically connecting the antenna element to the radio circuit.

By means of the configuration, the first hinge member located in the vicinity of the cable through which comparatively large antenna currents flow is operated as an earth line, whereby the opposite-phase antenna currents can be diminished more effectively, and the characteristic, such as an antenna gain, can be improved.

The present invention also includes the portable radio in which an electrical length of the first enclosure and an electrical length of the second enclosure achieved in a direction of their short sides are shorter than a quarter of a wavelength of an operating frequency of the radio circuit.

By means of the configuration, even when the electrical length of the first enclosure and the electrical length of the second enclosure achieved in the direction of their short sides are shorter than a quarter of a wavelength of an operating frequency of the radio circuit; the electrical length of the first enclosure and the electrical length of the second enclosure achieved in the direction of their long sides are longer than the quarter of a wavelength of an operating frequency of the radio circuit; and the influence of the opposite-phase antenna currents that flow through the neighborhoods of the ends of the mutually-opposing enclosures in close proximity to each other is large, the first hinge member can be caused to act as an earth line, and it becomes possible to enhance the characteristic, such as an antenna gain, without impairment of the design characteristic of the enclosures, while making the portable radio feasible to accomplish a reduction in size and thickness.

### ADVANTAGE OF THE INVENTION

The present invention can provide a portable radio that can reduce an antenna current, which are oriented in opposite directions and which flow through enclosures, without impairment of a design characteristic of the enclosures while being feasible to accomplish a reduction in size and thickness.

### BRIEF DESCRIPTION OF THE DRAWINGS

FIG. 1 is a plan view showing a configuration of a principal section of a portable radio of a first embodiment of the present invention.

FIG. 2 is a front view showing an external view of the portable radio of the first embodiment achieved in its landscape open state.

FIG. 3 is a front view showing an external view of the portable radio of the first embodiment achieved in its portrait open state.

FIG. 4 is a schematic diagram illustrating a state of distribution of an antenna current on enclosures achieved when no earth line is provided.

FIG. 5 is a plan view showing another example configuration of the portable radio provided with an earth line.

FIG. 6 is a schematic view illustrating a state of distribution of antenna currents in the enclosures achieved when the earth line is provided.

FIG. 7 is a characteristic drawing showing antenna characteristics of an enclosure dipole antenna.

FIG. 8 is a plan view showing a configuration of a principal section of a portable radio of a second embodiment of the present invention.

FIG. 9 is a section diagram showing a connection state of an electric circuit achieved in its landscape open state of the portable radio of the second embodiment.

FIG. 10 is a section diagram showing a connection state of the electric circuit achieved in its portrait open state of the portable radio of the second embodiment.

### DESCRIPTIONS OF THE REFERENCE NUMERALS

11 UPPER ENCLOSURE
12 LOWER ENCLOSURE
13 INTERMEDIATE ENCLOSURE
15 ANTENNA ELEMENT
21 FIRST CIRCUIT BOARD
22 SECOND CIRCUIT BOARD
23 RADIO CIRCUIT
24, 27 MATCHING CIRCUIT
25 CONNECTION LINE
26 CONNECTION CONDUCTOR
31 FIRST HINGE MEMBER
32 SECOND HINGE MEMBER
35 REACTANCE ELEMENT
36 CONNECTION CABLE
41 FIRST SWITCHING CIRCUIT
42 SECOND SWITCHING CIRCUIT
43 CONTROL CIRCUIT
51 DISPLAY SECTION
52 OPERATION SECTION

### BEST MODES FOR IMPLEMENTING THE INVENTION

Embodiments show, by way of a portable radio, example configurations in which a portable radio of the present invention is applied to a portable phone terminal, or the like, that is used in a mobile communication system, such as a portable phone, and that has a cellular radio communication function and a digital broadcast receiving function.

### First Embodiment

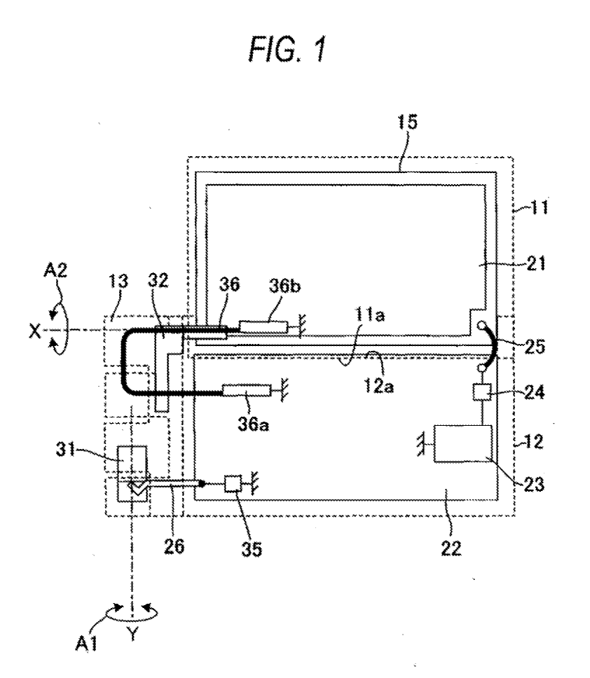

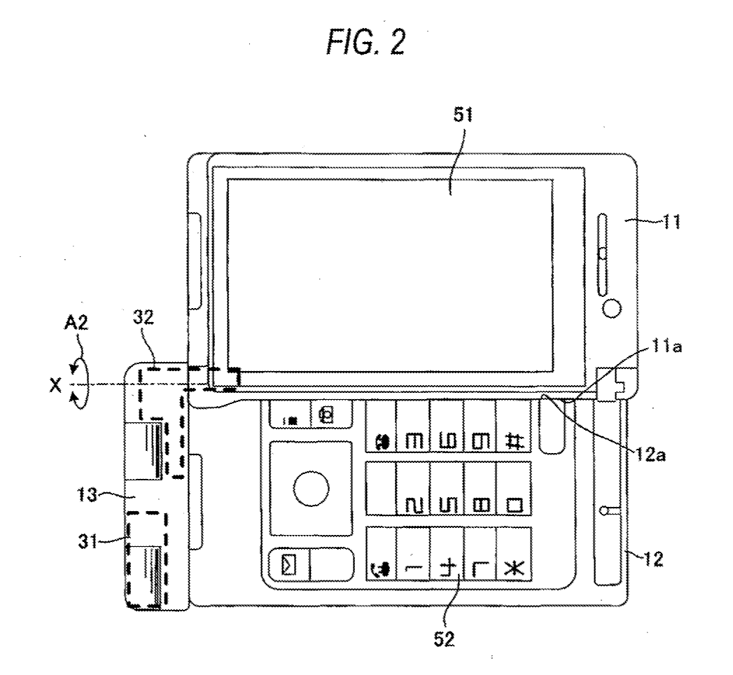

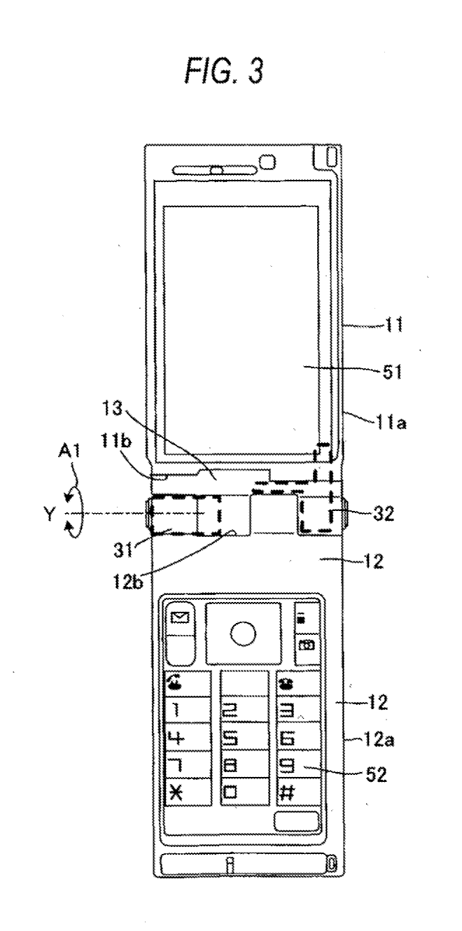

FIG. 1 is a plan view showing a configuration of a principal section of a portable radio of a first embodiment of the present invention. The portable radio of the present embodiment is an example configuration that can apply to a portable phone terminal having a foldable enclosure. The enclosure of the portable radio of the first embodiment has an upper enclosure 11 serving as a first enclosure; a lower enclosure 12 serving as a second enclosure; and an intermediate enclosure 13 that is provided, as a hinge section, in a joint area between the first and second enclosures and that is comparatively small. The upper enclosure 11 and the lower enclosure 12 can assume a portrait open state in which the enclosures turn around their respective single short sides, to thus open, and a landscape open state in which the enclosures turn around their respective single long sides, to thus open. FIG. 1 shows a configuration of the portable radio achieved in a landscape open state. FIG. 2 is a front view showing an external view of the portable radio of the first embodiment achieved in a landscape open state. FIG. 3 is a front view showing an external view of the portable radio of the first embodiment achieved in a portrait open state. The upper enclosure 11 and the lower enclosure 12 are formed into an elongated rectangular shape. In FIGS. 1 through 3, a long side of the upper enclosure 11 is designated by reference numeral 11a; a long side of the lower enclosure 12 is designated by reference numeral 12a; a short side of the upper enclosure 11 is designated by reference numeral 11b; and a short side of the lower enclosure 12 is designated by reference numeral 12b.

A first hinge member 31 serving as a first hinge member and a second hinge member 32 serving as a second hinge member are provided in the intermediate enclosure 13. The first hinge member 31 joins the lower enclosure 12, the intermediate enclosure 13, and the upper enclosure 11 while relatively rotatable around the position of an axis designated by reference symbol Y shown in FIG. 1 and in the direction of an arrow A1. The second hinge member 32 joins the lower enclosure 12, the intermediate enclosure 13, and the upper enclosure 11 while relatively rotatable around the position of an axis designated by reference symbol X shown in FIG. 1 and in the direction of an arrow A2. Specifically, the upper enclosure 11 is joined to and supported by the lower enclosure 12 by way of the intermediate enclosure 13.

Consequently, the enclosure of the portable radio has two degrees of freedom and is configured so as to be deformable. For instance, the upper enclosure 11 is turned around the axis X by means of the second hinge member 32 with respect to the intermediate enclosure 13 in the direction of the arrow A2 while the upper enclosure 11 and the lower enclosure 12 remain overlapping each other. Thereby, as shown in FIGS. 1 and 2, it is possible to achieve bring the portable radio into a landscape open state in which the enclosures are opened in a horizontally long state with the long side 12′a on an upper end of the lower enclosure 12 in the drawing and the long side 11a on a lower end of the upper enclosure 11 in the drawing remain in close proximity to each other. Moreover, when the enclosures are turned in an opposite direction, the enclosures can be folded, to thus be brought into a state in which the upper enclosure 11 and the lower enclosure 12 overlap each other.

The enclosures are turned in the direction of the arrow A1 around the axis Y by means of the first hinge member 31 while the upper enclosure 11 and the lower enclosure 12 overlap each other. Thereby, as shown in FIG. 3, it is possible to bring the portable radio into a portrait open state in which the enclosures are opened in a narrow, elongated shape while the short side 12b on the upper end of the lower enclosure 12 in the drawing and the short side 11b on the lower end of the upper enclosure 11 in the drawing come close to each other with the intermediate enclosure 13 sandwiched therebetween. Moreover, when the enclosures are turned in an opposite direction, the enclosures can be folded, to thus be brought into a state in which the upper enclosure 11 and the lower enclosure 12 overlap each other. Consequently, the enclosures can be used in any one of three types of states; namely, the portrait open state, the landscape open state, and the closed state.

The upper enclosure 11 is provided with a first circuit board 21, and the lower enclosure 12 is provided with a second circuit board 22. Like a common portable phone terminal, a display section 51 made up of a liquid display device, or the like, and relevant electric circuits are built in the upper enclosure 11. These constituent elements are placed on the first circuit board 21. Various electric circuits, which include a control section, a radio section, and others, and the operation section 52 are built in the lower enclosure 12. The constituent elements are mounted on the second circuit board 22.

The second circuit board 22 of the lower enclosure 12 and the first circuit board 21 of the upper enclosure 11 are electrically connected together by way of a connection cable 36. The connection cable 36 is a flexible cable formed from a coaxial cable and inserted into a hinge section of the intermediate enclosure 13. A power line, an earth line, necessary signal lines, and the like, of the first circuit board 21 are electrically connected to the second circuit board 22, by means of the connection cable 36. A shield conductor of the coaxial cable of the connection cable 36 is connected to a ground on the first circuit board 21 and a ground on the second circuit board 22. In the example shown in FIG. 1, the connection cable 36 connects the first circuit board 21 to the second circuit board 22 by way of a path running through an interior of the hinge section of the intermediate enclosure 13. One end of the connection cable 36 is connected to a neighborhood of an end of the second circuit board 22 close to the intermediate enclosure 13 (a neighborhood of a left end in FIG. 1) by way of a connector 36a, and the other end of the connection cable 36 is connected to a neighborhood of an end of the first circuit board 21 facing the intermediate enclosure 13 (the neighborhood of the left end in FIG. 1) by way of a connector 36b.

The portable radio of the present embodiment is equipped with, as a radio function, a digital broadcast receiving function for receiving a digital broadcast (DTV). An enclosure dipole antenna that lets an enclosure itself operate as an antenna is configured as an antenna for receiving a digital broadcast. Although un-illustrated, the portable radio, as a portable phone terminal, can also be equipped with a cellular radio communication function that is used to assure a communication line for the purpose of voice conversation and packet communication.

A radio circuit 23 for receiving a digital broadcast is arranged on the second circuit board 22. The radio circuit 23 performs processing for receiving a radio signal having a frequency band used in a digital broadcast. A frequency band ranging from 473 to 770 MHz is assumed herein to be used for receiving a digital broadcast. When the portable radio is equipped with a cellular radio communication function, the portable radio is equipped with a radio circuit and an antenna for a cellular radio communication function. A frequency band of; for instance, about 800 MHz (ranging from 830 to 885 MHz), is used for cellular radio communication, and a monopole antenna is used as the antenna.

In the enclosure of the portable radio, the principal portion of the upper enclosure 11 is formed from a conductive metal frame that is an antenna element 15 and has a radiation area that is substantially the same as the shape of the enclosure. The principal portion of the lower enclosure 12 is likewise formed from a conductive metal frame that is to serve as an antenna element. In the landscape open state shown in FIG. 1, the second circuit board 22 of the lower enclosure 12 and the antenna element 15 of the upper enclosure 11 are electrically connected together, by means of a connection line 25 formed from a conductor, in the vicinity of the end of the enclosure opposite to the intermediate enclosure 13. On this occasion, one end of the connection line 25 is connected to the antenna element 15, and the other end of the connection line 25 is connected to a matching circuit 24 and further connected to an input terminal of the radio circuit 23 by way of the matching circuit 24. Specifically, in the landscape open state, the connection line 25 is utilized as a path for connection to the antenna, and the antenna element 15 that is a portion of the enclosure dipole antenna is connected to the radio circuit 23. By means of such a configuration, the enclosure dipole antenna using two enclosures as antenna elements can be caused to operate through use of the antenna element 15 of the upper enclosure 11 and a ground pattern of the second circuit board 22 of the lower enclosure 12. In the portrait open state shown in FIG. 3, the upper enclosure 11 and the lower enclosure 12 are electromagnetically coupled, to thus act as an enclosure dipole antenna. Now, in the portrait open state, a path for connection to the antenna element 15 can also be formed by use of a connection member other than the connection line 25.

The first hinge member 31 provided in the intermediate enclosure 13 is formed from a conductive metal member. In the present embodiment, the first hinge member 31 is utilized as an earth line. A connection conductor 26 that is formed from an elastically, deformable elongated conductive member and that serves as a connector is interposed between the first hinge member 31 and the second circuit board 22 of the lower enclosure 12. One end of the connection conductor 26 is connected and earthed to the ground on the second circuit board 22 by way of a reactance element 35, and the other end of the connection conductor 26 remains in contact with and electrical conduction to the first hinge member 31. The connection conductor 26 electrically connects the second circuit board 22 to the first hinge member 31. For instance, a 47-nH coil is used as the reactance element 35.

It is desirable to set an electric length L1 of a conductor element that is made up of the first hinge member 31 and the connection conductor 26 and that serves as an earth line to about a quarter of a wavelength λ of the frequency band (an operating frequency band) of a radio signal received by the radio circuit 23 (e.g., about 100 mm). Even when the electrical length L1 is shorter than (¼) λ, the reactance element 35 is provided, whereby the first hinge member 31 can be utilized and made function as an earth line. In the landscape, open state, a distance L2 from the positions of the long sides 11a and 12a where both of the enclosures remain in close proximity to each other and the position of the connection cable 36 to the first hinge member 31 is set to under quarter of the wavelength λ of the operating frequency band. A long-side length La (an electrical length achieved in the direction of the long side) of each of the upper enclosure 11 and the lower enclosure 12 is set to; for instance, about a quarter (about 100 mm) of the wavelength λ of the operating frequency band, and a short-side length Lb (an electrical length achieved in the direction of the short side) of the same is made shorter than La; namely, Lb is set to less than a quarter of the wavelength λ of the operating frequency band.

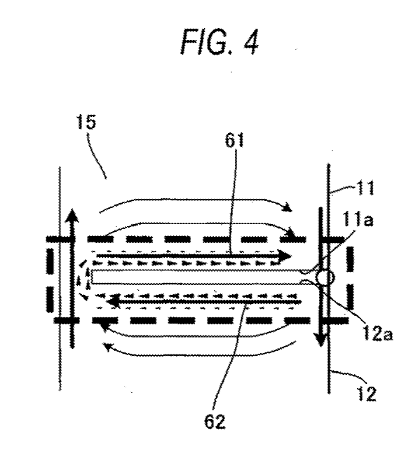

FIG. 4 is a schematic diagram illustrating a state of distribution of antenna currents on the enclosures achieved when the earth line is not provided. When the enclosure dipole antenna in the portable radio having foldable enclosures is caused to operate, the state of distribution of antenna currents achieved in the upper enclosure 11 and the lower enclosure 12 comes to a state, such as that shown in FIG. 4. In the neighborhood of the end where the upper enclosure 11 and the lower enclosure 12 remain in close proximity to each other, an antenna current 61 flowing through the upper enclosure 11 and an antenna current 62 flowing through the lower enclosure 12 become opposite in direction (i.e., electric currents having opposite phases flow in the neighborhood of the end), and hence both of the antenna currents come to cancel each other. Overall antenna currents are thereby reduced, and an effective radiation area of the entire enclosure dipole antenna is also reduced. A reduction in radiation area of the antenna leads to narrowing of the frequency band at which a sufficient antenna gain is acquired, so that an antenna characteristic is deteriorated.

The sides (the long sides 11a and 12a) where the upper enclosure 11 and the lower enclosure 12 are in close proximity to each other become longer particularly in the landscape open state. The length (the electrical length) La of each of the long sides 11a and 12a is now set to about a quarter (about 100 mm) of the wavelength λ of the operating frequency band. Electrical lengths of the long sides 11a and 12a accounting for the wavelength of the operating frequency band become greater, and hence the influence of cancellation of the antenna currents caused by the opposite-phase currents becomes greater. Moreover, when the dipole antenna is used as an antenna for receiving a digital broadcast, a wavelength of the corresponding frequency band (473 to 770 MHz) is comparatively longer than the size of the enclosure and also has a wider band. Therefore, deterioration of the antenna characteristic becomes noticeable. Accordingly, conceivable countermeasure for reducing such opposite-phase electric currents and suppressing deterioration of the characteristics caused by the influence of the cancellation of the antenna currents is to provide an earth line.

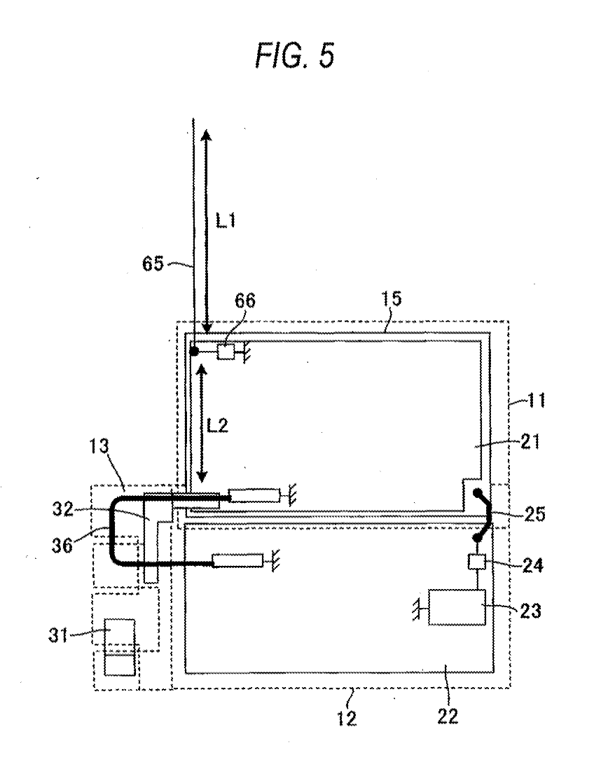

FIG. 5 is a plan view showing another example configuration of the portable radio equipped with an earth line. In the example configuration shown in FIG. 5, the upper enclosure 11 is provided with a conductive element 65 that is to serve as an earth line. One end of the conductive element 65 is connected to the ground on the first circuit board 21 of the upper enclosure 11 by way of a reactance element 66, to thus be earthed, and another end of the conductor element 65 protrudes out of the upper enclosure 11. An electrical length of the conductor element 65 serving as an earth line and an electrical length of the reactance element 66 are set to about a quarter of the wavelength λ of the operating frequency band of the radio circuit 23 (e.g., about 100 mm). In the landscape open state, the distance L2 from the positions of the long sides 11a and 12a, where both of the enclosures come into close proximity to each other, and the position of the connection cable 36 to the conductor element 65 is set to under quarter of the wavelength λ of the operating frequency band.

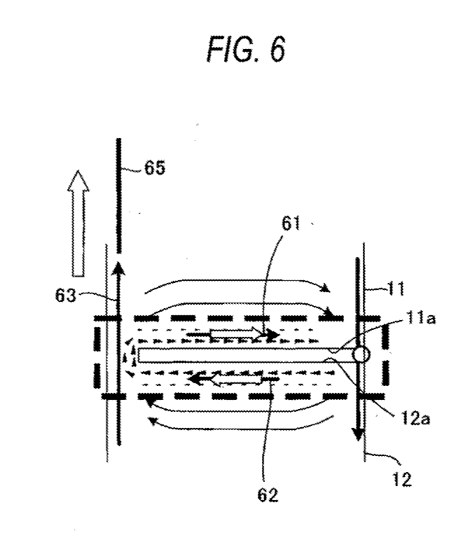

FIG. 6 is a schematic view illustrating a state of distribution of antenna currents in the enclosure achieved when an earth line is provided. An earth line is provided when the enclosure dipole antenna is caused to operate, whereby the state of distribution of antenna currents on the enclosure changes. The conductor element 65 that is to serve as an earth line is placed at a position that is distant, by a distance of less than a quarter of the wavelength λ of the operating frequency band, from the positions of the long sides 11a and 12a where the upper enclosure 11 and the lower enclosure 12 are in close proximity to each other and the position of the connection cable 36. As a result, the conductor element 65 including the reactance element 66 produces resonance at a predetermined frequency, whereupon an antenna current 63 flowing in a direction in which the conductor element 65 is present increases. As a consequence, the antenna currents 61 and 62 flowing in a direction parallel to the long sides 11a and 12a in the vicinity of the end where the upper enclosure 11 and the lower enclosure 12 are in close proximity to each other decrease. Since the opposite-phase electric currents that cancel each other resultantly decrease, a decrease in the radiation area of the antenna is prevented.

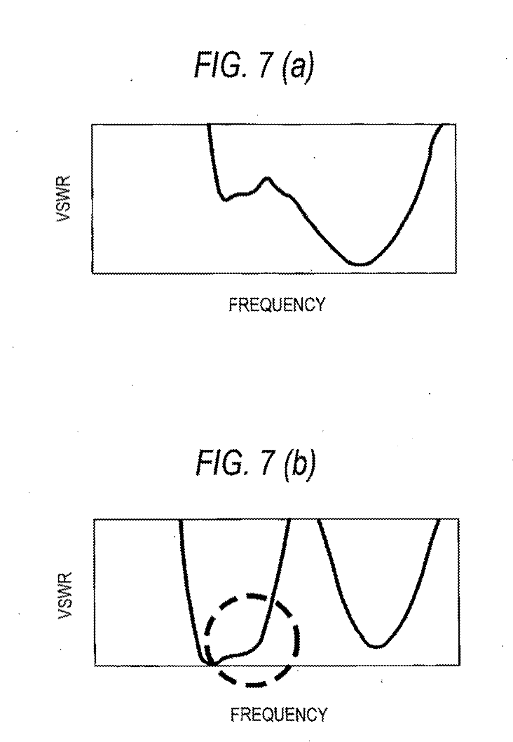

FIG. 7 is a characteristic drawing showing a frequency characteristic of a VSWR (Voltage Standing Wave Ratio) as an antenna characteristic of the enclosure dipole antenna. The characteristic drawing of FIG. 7 shows a result of simulation performed by use of a computer. FIG. 7(a) shows a characteristic yielded when no earth line is provided, and FIG. 7(b) shows a characteristic yielded when an earth line is provided. When the antenna currents are reduced by the opposite-phase currents, to thus lead to a decrease in the radiation area of the antenna, as shown in FIG. 4, a frequency band where the VSWR is sufficiently small (superior) and where a desired antenna gain is produced becomes narrower as illustrated in FIG. 7(a), so that an antenna characteristic becomes worse [a VSWR at a low frequency is large (inferior), and deterioration of the antenna characteristic is noticeable]. In particular, the deterioration of the antenna characteristic becomes noticeable in applications where radio waves of wide frequency bands (ranging from 473 to 770 MHz) as in a digital broadcast must be received. On the contrary, when the decrease in antenna currents is suppressed by providing the earth line as shown in FIG. 5, the VSWR is improved as shown in FIG. 7(b). Specifically, the VSWR characteristic yielded at the low frequency range is improved by resonance of the earth line, whereby broadening of the band can be achieved. In the example configuration shown in FIG. 5, the antenna gain yielded in the operating frequency band can be improved by about 5 dB.

When the linear conductor element 65 is provided as an earth line as in the example configuration shown in FIG. 5, there is a case where the conductor element is arranged so as to protrude to the outside of the enclosure and where the enclosure will become larger in size in order to assure space for placing the conductor element. For these reasons, there is adopted a configuration, as in the case of the first embodiment shown in FIG. 1, in which the conductive first hinge member 31 provided in the intermediate enclosure 13 where the hinge section is provided is utilized and caused to act as an earth line. In this case, the first hinge member 31 including the reactance element 35 and the conductor element formed from the connection conductor 26 produce resonance at the operating frequency band of the radio circuit 23, whereupon the radio circuit acts as an earth line. Therefore, a change occurs in the state of distribution of the antenna currents in the enclosure dipole antenna in the same manner as in the example shown in FIG. 6. Specifically, the antenna currents flowing toward the first hinge member 31 increase, and a decrease occurs in the antenna currents oriented in opposite directions in the neighborhoods of the long sides 11a and 12a where the upper enclosure 11 and the lower enclosure 12 are in close proximity to each other.

The connection cable 36 is inserted into the interior of the intermediate enclosure 13 and placed at a position close to the first hinge member 31. A test shows that comparatively high antenna currents flow through the connection cable 36 that connects the first circuit board 21 to the second circuit board 22. Therefore, the connection cable 36 is arranged at a position close to the first hinge member 31, whereby the influence of the first hinge member 31 acting as an earth line on the state of distribution of the antenna currents on the enclosure dipole antenna becomes greater, so that a decrease in the antenna currents caused by cancellation of the opposite-phase currents can be effectively prevented. The antenna characteristic can thereby be improved, and a wideband enclosure dipole antenna can be implemented. In an example configuration shown in FIG. 1, the simulation performed by use of a computer shows that the VSWR characteristic achieved at the low frequency band is improved by resonance of the earth line in the same manner as in the example configuration shown in FIG. 5. The antenna gain yielded at the operating frequency band can be improved by about 3 dB.

As mentioned above, according to the present embodiment, the first hinge member 31 is caused to operate as an earth line, thereby obviating a necessity for additional provision of a new constituent member for an earth line, and can be given a function of an earth line. It becomes possible to reduce opposite-phase electric currents of the enclosure dipole antenna flowing through the sides on the ends of the enclosures that oppose each other in close proximity to each other. A decrease in the radiation area of the antenna can thereby be prevented, and deterioration of a characteristic, such as a VSWR, is prevented, whereby the antenna characteristic can be improved. In this case, a conductor element of the earth line does not protrude from the enclosure, and space for additional arrangement is also unnecessary. Therefore, it is possible to enhance a design characteristic of the enclosures, and also a reduction in size and thickness also become easily feasible to accomplish.

### Second Embodiment

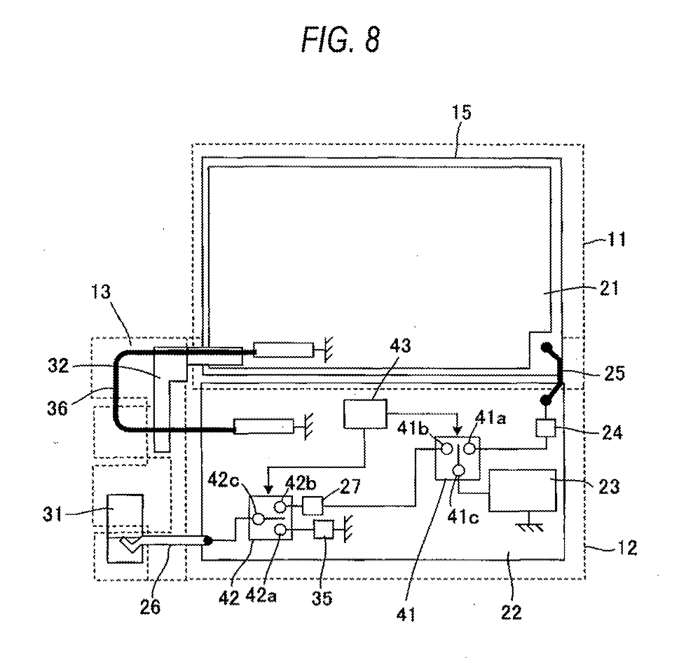

FIG. 8 is a plan view showing a configuration of a principal section of a portable radio of a second embodiment of the present invention. The second embodiment is a modification of the first embodiment and is provided with a configuration in which the connection of the first hinge member 31 that is to serve as an earth line is switched according to an open or close state. Constituent elements that are the same as those described in connection with the first embodiment are assigned the same reference numerals, and their explanations are omitted.

In the portable radio of the second embodiment, in addition to including the radio circuit 23 and the matching circuit 24, the second circuit board 22 of the lower enclosure 12 has thereon a first switching circuit 41 serving as a first switching circuit, a second switching circuit 42 serving as a second switching circuit, a control circuit 43, and a matching circuit 27. In other respects, the second embodiment is identical with the first embodiment.

The first switching circuit 41 is a switching circuit for switching a connection path between the radio circuit 23 and the antenna. The second switching circuit 42 is a switching circuit for switching a connection path between the first hinge member 31 and the connection conductor 26. The first switching circuit 41 and the second switching circuit 42 can switch a connection state according to a control signal from the control circuit 43.

One connection terminal 41a of the first switching circuit 41 is connected to the connection line 25 and the antenna element 15 by way of the matching circuit 24. Another connection terminal 41b of the first switching circuit 41 is connected to the second switching circuit 42 by way of the matching circuit 27. A common terminal 41c of the first switching circuit 41 is connected to an input terminal of the radio circuit 23.

One connection terminal 42a of the second switching circuit 42 is earthed by way of the reactance element 35, and another connection terminal 42b of the second switching circuit 42 is connected to the other connection terminal 41b of the first switching circuit 41 by way of the matching circuit 27. A common terminal 42c of the second switching circuit 42 is connected to the connection conductor 26 and is electrically connected to the first hinge member 31 by way of the connection conductor 26.

The control circuit 43 outputs a single control signal to both the first switching circuit 41 and the second switching circuit 42, thereby controlling and switching between a connection state of the first switching circuit 41 and a connection state of the second switching circuit 42. On this occasion, the control circuit 43 detects the presence or absence of the landscape open state of the enclosure of the portable radio by means of an un-illustrated sensor (e.g., a switch, a magnet and hall element, and the like) and automatically switches between the connection state of the first switching circuit 41 and the connection state of the second switching circuit 42, according to the landscape open state of the enclosures.

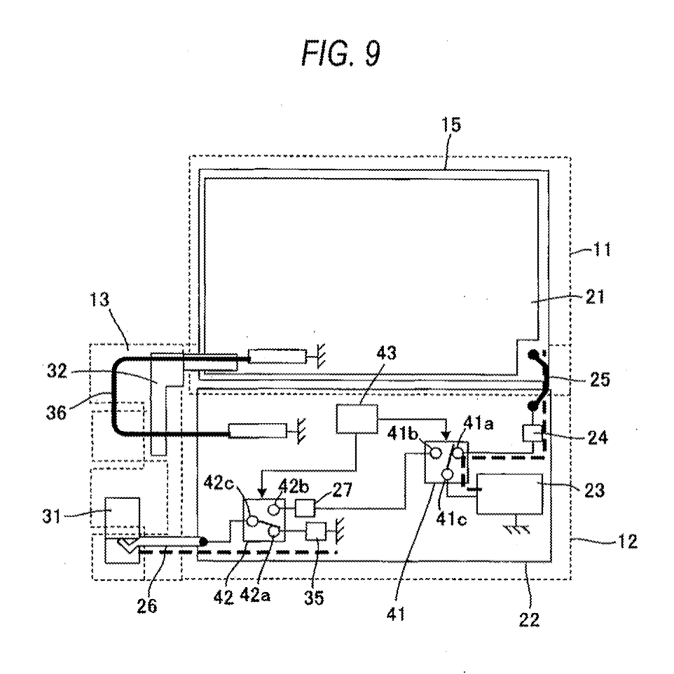

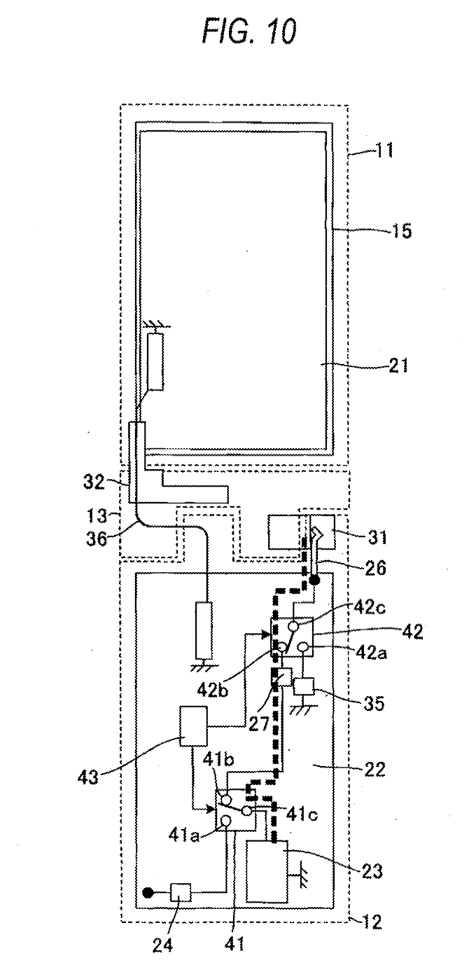

FIG. 9 is a section diagram showing a connection state of an electric circuit achieved in the landscape open state of the portable radio of the second embodiment. FIG. 10 is a section diagram showing a connection state of the electric circuit achieved in the portrait open state of the portable radio of the second embodiment.

When the enclosures are in a landscape open state, the control circuit 43 controls a connection state as a first connection state in such a way that the connection terminal 41a and the common terminal 41c of the first switching circuit 41 are connected together and that the connection terminal 42a and the common terminal 42c of the second switching circuit 42 are connected together, as shown in FIG. 9. When the enclosures are in a portrait open state (not in the landscape open state), the control circuit 43 controls a connection state as a second connection state in such a way that the connection terminal 41b and the common terminal 41c of the first switching circuit 41 are connected together and that the connection terminal 42b and the common terminal 42c of the second switching circuit 42 are connected together, as shown in FIG. 10.

As in the first embodiment shown in FIG. 1, the antenna element 15 is connected to an input terminal of the radio circuit 23 by way of the connection line 25, the matching circuit 24, and the first switching circuit 41 when the enclosures are in the landscape open state. Concurrently, the first hinge member 31 is earthed by way of the connection conductor 26, the second switching circuit 42, and the reactance element 35.

In the meantime, the input terminal of the radio circuit 23 is electrically disconnected from the connection line 25 and the matching circuit 24 when the enclosures are in a portrait open state and, instead, is electrically connected to the connection conductor 26 and the first hinge member 31 by way of the first switching circuit 41, the matching circuit 27, and the second switching circuit 42. The reactance element 35 is disconnected from the connection conductor 26 and the first hinge member 31.

As mentioned above, in the landscape open state, the first hinge member 31 and the connection conductor 26 are earthed by way of the reactance element 35, and the first hinge member 31 acts as an earth line. On the contrary, in the portrait open state, the first hinge member 31 and the connection conductor 26 are disconnected from the reactance element 35 and acts as a portion of the antenna connected to the radio circuit 23 and as a path for connection with the antenna element 15. In this case, the antenna element 15 of the upper enclosure 11 and the first hinge member 31 are not directly connected together. However, they are arranged in close proximity to each other, and hence the upper enclosure 11 and the lower enclosure 12 are electromagnetically coupled at a radio frequency, to thus operate as an enclosure dipole antenna. There may also be adopted a configuration in which the first hinge member 31 and the antenna element 15 of the upper enclosure 11 are electrically connected together in the portrait open state.

In the second embodiment, in a state in which the influence of cancellation of the antenna currents having opposite phases is great, as in the landscape state in which the long side 11a of the upper enclosure 11 and the long side 12a of the lower enclosure 12 remain in close proximity to each other, it is possible to improve the characteristic of the enclosure dipole antenna by letting the first hinge member 31 act as an earth line and reducing the opposite-phase electric currents flowing through the enclosures, to thus broaden the band. In the portrait open state in which the short side 11b of the upper enclosure 11 and the short side 12b of the lower enclosure 12 remain in close proximity to each other, the influence of the opposite-phase antenna currents becomes smaller. Therefore, the first hinge member 31 is utilized as an antenna or an antenna connection path without particular employment of an earth line, whereby the first hinge member 31 can be effectively utilized and make for miniaturization of the enclosures.

As mentioned above, in the present embodiment, when the plurality of separated enclosures are used as an enclosure dipole antenna, the conductive hinge member is earthed by way of the reactance element, to thus be utilized as an earth line. The opposite-phase electric currents flowing through both of the enclosures that are in close proximity to each other and that oppose each other are reduced, and the influence of cancellation of the antenna currents can be suppressed, so that a sufficient antenna gain can be obtained over a wide band. Moreover, in order to provide an earth line, there is no necessity to add another conductive member and provide a conductive element that protrudes out of the enclosure. Hence, factors that hinder a reduction in size and thickness of the enclosures can be avoided without impairing a design characteristic of the enclosures.

The embodiments have provided a case where the present invention is applied to a portable phone terminal having a cellular communication function and a digital broadcast receiving function. However, the present invention can likewise be applied to a compact portable radio, such as portable phone terminals having other various radio communication functions and broadcast receiving functions, portable information terminals (PDAs), and other electronic devices.

The present invention is not limited to the disclosures provided in the embodiments. The present invention is also scheduled to be susceptible to alterations and applications conceived by the skilled in the art from the descriptions of the present patent application and well-known techniques. The alterations and applications shall fall within a range in which protection is sought.

The present patent application is based on Japanese Patent Application (JP-A-2008-151976) filed on Jun. 10, 2008, the subject matters of which are incorporated herein by reference.

### INDUSTRIAL APPLICABILITY

The present invention yields an advantage of the ability to reduce antenna currents flowing in opposite directions through enclosures and enhance antenna characteristics while making it possible to achieve a reduction in size and thickness without impairing a design characteristic of enclosures and is useful as a portable radio, or the like, which has an antenna provided in enclosures; for instance, foldable enclosures.

1. A portable radio comprising:
a first enclosure;
a second enclosure;
a hinge section that joins the first enclosure to the second enclosure in a relatively rotatable or movable state;
an antenna element having a conductive member to be placed in the first enclosure;
a circuit board to be placed in the second enclosure;
a radio circuit that is placed on the circuit board and connected to the antenna element;
a conductive first hinge member and a conductive second hinge member that are provided in the hinge section and that have mutually-different rotational axes for turning the first enclosure and the second enclosure;
a reactance element that is provided on the circuit board and that is earthed at one end; and
a connector that electrically connects the first hinge member to the reactance element while the first enclosure and the second enclosure remain open as a result of turning action of the second hinge member.

2. The portable radio according to claim 1, wherein the first enclosure and the second enclosure each are formed into a shape having long sides and short sides; and
the first hinge member is earthed to the circuit board by the reactance element while the enclosures remain open with the long side of the first enclosure and the long side of the second enclosure in close proximity to each other.

3. The portable radio according to claim 2, wherein the first enclosure and the second enclosure are open-able and closable between a landscape open state in which the long sides come into close proximity to each other as a result of turning action of the second hinge member, to thus open the enclosures, and a portrait open state in which the short sides come into close proximity to each other as a result of turning action of the first hinge member, to thus open the enclosures; and
the first hinge member is earthed to the circuit board by the reactance element in the landscape open state.

4. The portable radio according to claim 1, further comprising:
a first switching circuit that switches a connection path of the radio circuit;
a second switching circuit that switches a connection path of the first hinge member; and
a control circuit that controls a state of connection of the first switching circuit and a state of connection of the second switching circuit, wherein
the control circuit selects, when the first enclosure and the second enclosure remain open as a result of turning action of the second hinge member, a first connection state in which the first switching circuit connects the radio circuit to the antenna element and in which the second switching circuit connects the first hinge member, the connector, and the reactance element together; and
the control circuit selects, when the first enclosure and the second enclosure remain closed as a result of turning action of the second hinge member, a second connection state in which the first switching circuit connects the radio circuit to the second switching circuit and in which the second switching circuit connects the first hinge member and the connector to the first switching circuit, thereby bringing the first hinge member in connection with the radio circuit.

5. The portable radio according to claim 4, wherein the first enclosure and the second enclosure each are configured into a shape having long sides and short sides and are open-able and closable between a landscape open state in which the long sides come in close proximity to each other as a result of turning action of the second hinge member, to thus open the enclosures, and a portrait open state in which the short sides come into close proximity to each other as a result of turning action of the first hinge member, to thus open the enclosures; and
the control circuit selects the first connection state in the landscape open state and the second connection state in the portrait open state.

6. The portable radio according to claim 1, further comprising:
a cable that is laid by the hinge section and that electrically connects the antenna element to the circuit board; and
a connection path for electrically connecting the antenna element to the radio circuit.

7. The portable radio according to claim 2, wherein an electrical length of the first enclosure and an electrical length of the second enclosure achieved in a direction of their short sides are shorter than a quarter of a wavelength of an operating frequency of the radio circuit.
